(19) United States
(12) Patent Application Publication
(10) Pub. No.: US 2023/0306515 A1
(43) Pub. Date: Sep. 28, 2023

(54) Systems and Computer-Implemented Methods for Capital Management

(71) Applicant: Xero Limited, Wellington (NZ)

(72) Inventors: Benjamin Lloyd Styles, Wellington (NZ); Donald John Robert Permezel, Wellington (NZ); Philip Gardiner, Wellington (NZ); Antoine Merval, Wellington (NZ)

(21) Appl. No.: 17/902,392

(22) PCT Filed: Sep. 3, 2020
(86) PCT No.: PCT/AU2020/050924

§ 371 Date: Sep. 2, 2022

(30) Foreign Application Priority Data
Apr. 15, 2020 (AU) 2020901197

(51) Int. Cl. G06Q 40/06

(52) U.S. Cl. CPC G06Q 40/06

(57) ABSTRACT

A computer implemented method for managing capital for a primary entity. The method comprising: determining a baseline cash flow forecast for a time frame based on financial data associated with the primary entity for that time frame; determining one or more sub-time frames of the time frame where cash flow is predicted to be in surplus or deficit; and based on the determined sub-time frames, generating by a recommendation engine one or more recommendations to improve capital management for the primary entity.

### TECHNICAL FIELD

Described embodiments relate to systems and computer implemented methods for capital management.

### BACKGROUND

Effective capital management enables business or trading entities to ensure adequate access to funds necessary for operational expenses while making sure that the entity's assets are invested in the most financially productive manner. In fact, the majority of businesses that fail, do so because of cash flow problems.

Capital management may involve consideration of a wide range of factors including: outstanding receivables, obsolete inventory, cost of short term debt, payment obligations, liquidity and trading obligations of trading partner entities, short term investment yields. Taking into account the large range of dynamic factors relevant for effective capital management is a computationally complex, time and labour intensive operation, and can be an arduous and error prone process.

It is desired to address or ameliorate some of the disadvantages associated with prior methods and systems for processing images for docket detection and information extraction, or at least to provide a useful alternative thereto.

Any discussion of documents, acts, materials, devices, articles or the like which has been included in the present specification is not to be taken as an admission that any or all of these matters form part of the prior art base or were common general knowledge in the field relevant to the present disclosure as it existed before the priority date of each claim of this application.

Throughout this specification the word “comprise”, or variations such as “comprises” or “comprising”, will be understood to imply the inclusion of a stated element, integer or step, or group of elements, integers or steps, but not the exclusion of any other element, integer or step, or group of elements, integers or steps.

### SUMMARY

Some embodiments relate to a computer implemented method for managing capital for a primary entity, the method comprising: determining a baseline cash flow forecast for a time frame based on financial data associated with the primary entity for that time frame; determining one or more sub-time frames of the time frame where cash flow is predicted to be in surplus or deficit; based on the determined sub-time frames, generating by a recommendation engine one or more recommendations to improve capital management for the primary entity, wherein determining the baseline cash flow forecast for the time frame comprises assessing the financial data to determine predicted capital surplus and/or capital deficit within the time frame.

In some embodiments, the financial data comprises transactions between the primary entity and one or more other entities.

In some embodiments, determining the baseline cash flow forecast comprises: determining a trend component based on the financial data associated with the primary entity for that time frame, determining a first seasonality component based on the financial data, projecting the trend component and the first seasonality component to the time frame to determine the baseline cash flow forecast.

In some embodiments, determining the baseline cash for forecast comprises: determining the first seasonality component based on a first periodicity in the financial data; determining a fitness metric by comparing the financial data with the trend model and the seasonality component; if the determined fitness metric is below a predetermined fitness threshold, determining a second seasonality component based on a second periodicity in the financial data; and projecting the trend component and the second seasonality component to the time frame to determine the baseline cash flow forecast.

In some embodiments, the first periodicity is larger than the second periodicity.

In some embodiments, the method further comprises predicting a likelihood or probability of receiving payment of each invoice having a due date in the time frame and determining a modified cash flow forecast for the time frame based on the predictions.

In some embodiments, predicting a probability of receiving payment of each invoice having a due date in the time frame comprises determining an action score for a secondary entity associated with each invoice, wherein the action score is based on historic payment behaviours of the respective secondary entity, and determining the probability of the second entity paying the invoice within a given payment period, wherein the given period falls within the time frame.

In some embodiments, the given period is a specific day within the time frame.

In some embodiments, the method further comprises generating a cash flow forecast tool within a graphical user interface (GUI) of a display device, wherein the cash flow forecast tool depicts a representation of the baseline cash flow forecast and the one or more recommendations.

In some embodiments, the one or more recommendations comprise recommendations to adjust the financial data to manage the predicted cash flow during the one or more sub-time frames.

In some embodiments, in response to detecting user selection of one or more of the one or more suggestions using the cash flow forecast tool, adjusting the financial data in accordance with the selected one or more suggestions, determining a modified cash flow forecast for the time frame based on the adjusted financial data and depicting a representation of the modified cash flow forecast within the cash flow forecast tool.

In some embodiments, adjusting financial data comprises modifying a due date for payment on an invoice.

In some embodiments, the recommendations include one or more of: seeking early payment of an outstanding invoice, seeking an extended term for payment of an outstanding invoice, subscribing to a financial product, varying terms of at least one of the one or more transactions.

In some embodiments, the recommendations are generated based on one or more capital management target parameters comprising: debt to equity ratio for the entity, weighted average cost of capital to the entity, debt coverage ratio for the entity, number of debtor days for the entity or number of creditor days for the entity.

In some embodiments, the method further comprises automatically executing at least one of the recommendations based on the target parameters.

In some embodiments, the method further comprises analysing the automatically executed recommendations to determine whether the executed capital management recommendations mitigated the forecasted one or more cash flow shortfall periods or one or more cash flow excess periods; and revising the recommendation engine based on the analysis.

In some embodiments, the recommendation engine comprises one or more machine learning models and the revising the recommendation engine comprises training the machine learning model based on the analysis.

In some embodiments, the financial data comprises one or more of: bank account transaction data, invoice data, billings data, expense claim data, quote data, sales data, purchase order data, receivables data, transaction reconciliation data, balance sheet data, profit and loss data, or payroll data.

In some embodiments, the financial data comprises one or more financial records and each financial record comprises a transaction amount, a transaction date and one or more entity identifiers.

Some embodiments relate to a system for managing capital for a primary entity, the system comprising: one or more processors; a memory in communication with the one or more processor, the memory comprising program code which when executed by the one or more processors configures the one or more processors to: determine a baseline cash flow forecast for a time frame based on financial data associated with the primary entity for that time frame; determine one or more sub-time frames of the time frame where cash flow is predicted to be in surplus or deficit; based on the determined sub-time frames, generating by a recommendation engine one or more recommendations to improve capital management for the primary entity, wherein determining the baseline cash flow forecast for the time frame comprises assessing the financial data to determine predicted capital surplus and/or capital deficit within the time frame.

In some embodiments, the one or more processors are further configured to predict a likelihood or probability of receiving payment of each invoice having a due date in the time frame and determining a modified cash flow forecast for the time frame based on the predictions.

In some embodiments, the one or more processors are further configured to generate a cash flow forecast tool within a graphical user interface (GUI) of a display device, wherein the cash flow forecast tool depicts a representation of the baseline cash flow forecast and the one or more recommendations.

In some embodiments, the one or more processors are further configured to automatically execute at least one of the recommendations based on the target parameters.

In some embodiments, the one or more processors are further configured analyse the automatically executed recommendations to determine whether the executed capital management recommendations mitigated the forecasted one or more cash flow shortfall periods or one or more cash flow excess periods; and revising the recommendation engine based on the analysis.

Some embodiments relate to a machine-readable medium storing computer readable code, which when executed by one or more processors is configured to perform the method of according to any one of the embodiments.

### BRIEF DESCRIPTION OF DRAWINGS

FIG. 1 is a schematic diagram of a process for using a capital management platform to improve capital management of an entity, according to some embodiments;

FIG. 2 is a block diagram of the components of a capital management component, according to some embodiments;

FIG. 3 is an example screenshot of a visual display of a capital management tool provided by the capital management component of FIG. 2, according to some embodiments;

FIG. 4 is a process flow diagram of a method for forecasting cash flow for an entity, according to some embodiments;

FIG. 5 illustrates a first and a second cash flow forecast chart obtained by implementing the process flow of FIG. 4;

FIG. 6 is a block diagram depicting an example capital management platform, according to some embodiments;

FIG. 7 is a process flow diagram a method for managing capital for an entity, according to some example embodiments;

FIG. 8 is a block diagram depicting an example application framework, according to some embodiments.

FIG. 9 is a block diagram depicting an example hosting infrastructure, according to some embodiments;

FIG. 10 is a block diagram depicting an example data centre system for implementing described embodiments; and

FIG. 11 is a block diagram illustrating; an example of a machine arranged to implement one or more described embodiments.

### DESCRIPTION OF EMBODIMENTS

Described embodiments relate to systems, computer implemented methods and computer programs for capital management, and in some embodiments, cash flow forecasting.

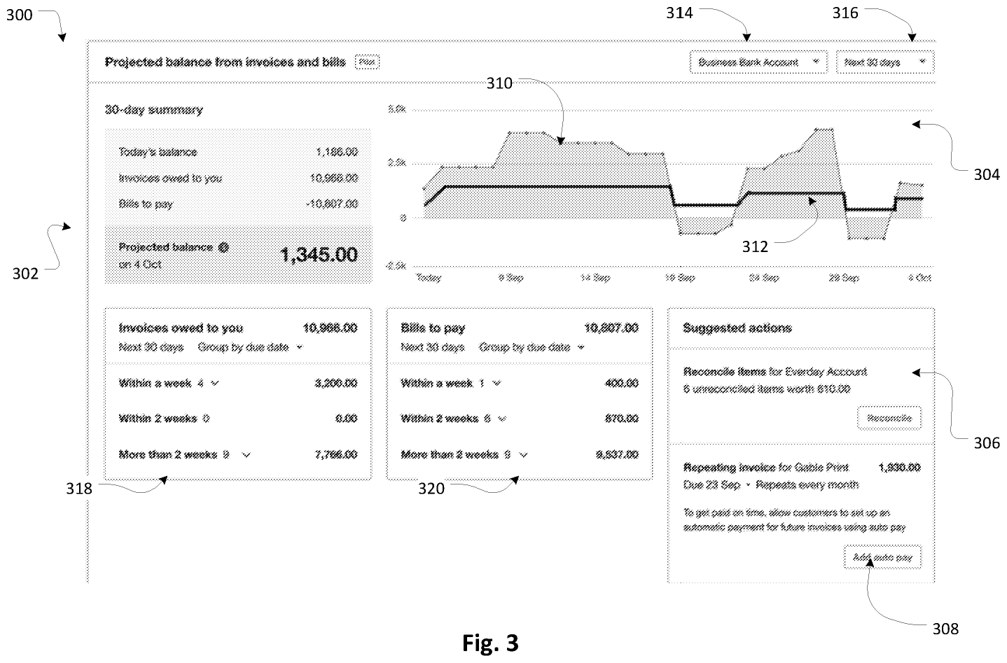

In some embodiments, a capital management platform, such as a cash flow forecasting platform or tool, is provided. The capital management platform is configured to determine predicted capital shortfalls and/or capital surpluses of an entity for a given period of time. The capital management platform may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. An example of such a graphical representation is presented is FIGS. 3 to 5, and discussed in more detail below.

The capital management platform may be configured to determine the predicted capital shortfalls and/or capital surpluses at a particular point or day in a given time period based on an assessment of financial data associated with the entity. Financial data associated with an entity may comprise banking data, such as banking received via a feed from a financial institution, accounting data, payments data, assets related data, transaction data, transaction reconciliation data, bank transaction data, expense data, tax related transaction data, inventory data, invoicing data, payroll data, purchase order data, quote related data or any other accounting entry data for an entity. The financial data may comprise one or more financial records. Each financial record may comprise a transaction amount, a transaction date, one or more due dates and one or more entity identifiers identifying the entities associated with the transaction. For example, financial data relating to an invoice may comprise a transaction amount corresponding to the amount owed, a transaction date corresponding to the date on which the invoice was issued, one or more payment due dates and entity identifiers indicating the invoice issuing entity and the entity under the obligation to pay the invoice. Financial data may also comprise financial records indicating terms of payment and other conditions associated with the financial transaction associated with the financial data.

In some embodiments, the capital management platform may be configured to predict capital shortfalls and/or capital surpluses for a primary entity over a time period based on data relating to historical or current payment behaviour or patterns of related entities, counterparties in transactions or third parties. In a highly interdependent trading environment, the further capital surplus or shortfall position of an entity may depend on the debt obligations or liquidity positions of the counterparties that the entity trades with or even third parties that the entity may not directly trade with. In some embodiments, the capital management platform may have access to data relating to historical payment behaviour of such counterparties or third parties to generate a more informed prediction of capital shortfalls and/or capital surpluses for the primary entity.

In some embodiments, capital management platform may be configured to generate suggestions or recommendations for more effective capital management based on the predicted capital shortfalls and/or capital surpluses. In some embodiments, capital management platform may be configured to take one or more actions in accordance for more effective capital management based on the suggestions or recommendations.

Examples merely typify possible variations. Unless explicitly stated otherwise, components and functions are optional and may be combined or subdivided, and operations may vary in sequence or be combined or subdivided. In the following description, for purposes of explanation, numerous specific details are set forth to provide a thorough understanding of example embodiments. It will be evident to one skilled in the art, however, that the present subject matter may be practiced without these specific details.

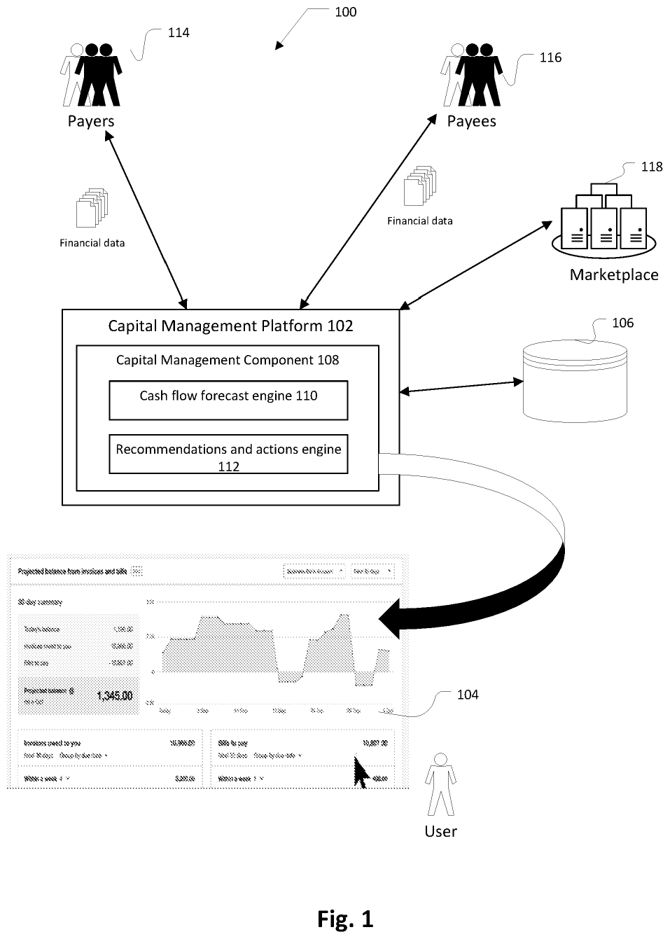

FIG. 1 illustrates a process 100 for using a capital management tool to improve capital management of an entity. In some embodiments, a capital management platform 102 may be provided to one or more client devices by one or more servers executing program code stored in memory. The capital management platform 102 may provide the capital management tool 104 for use by users of the one or more client devices. In some embodiments, the capital management platform 102 is arranged to communicate with a database 106 comprising financial information associated with a network of entities associated with the capital management platform, and my, for example, include accounting data for transactions between two or more entities. Accordingly, analysis of the data allows for inferences about the business interactions or transactions of those entities. For example, computational analysis of historical patterns of transactions between entities and trading behaviours of entities including responsiveness to financial obligations, may be used to predict behaviours of the entities.

In some embodiments, database 106 may be part of an accounting system, such as a cloud based accounting system configured to enable entities to manage their accounting or transactional data. The accounting or transactional data may include data relating to bank account transactions or transfers, invoice data, billings data, expense claim data, historical cash flow data, quotes related data, sales data, purchase order data, receivables data, transaction reconciliation data, balance sheet data, profit and loss data, payroll data, for example. Data in database 106 may enable identification of interrelationships between the primary entity and other entities based on the transactional data. The interrelationships may include relationships that define payment or debt obligations, for example. Based on the interrelationships between the primary entity and other entities, data in database 106 may be used to identify one or more networks of related entities that directly or indirectly transact with each other. Within a network of entities, the financial or cash flow position of one entity may have an impact on the financial or cash flow position of rest of the entities in the network.

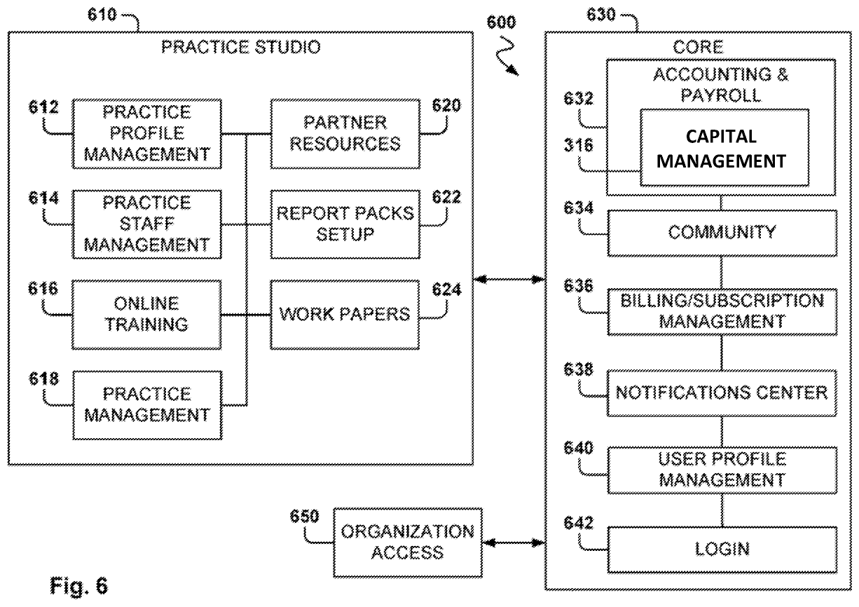

The capital management platform 102 may provide accounting tools to a particular entity managing accounting for one or more businesses, as discussed in more detail below with reference to FIG. 6.

The capital management tool 104 may be provided by one or more processors of the capital management platform 102 executing program code of a capital management component 108. The capital management component 108 may comprise a cash flow forecasting engine 110 and a recommendations and actions engine 112. The cash flow forecasting engine 110, when executed by the one or more processors of the capital management platform 102, may be configured to predict capital shortfalls and/or capital surpluses of an entity for a given period of time based on information derived from the database 106. For example, the cash flow forecasting engine 110 may predict a baseline capital shortfalls or baseline capital surpluses based on payment terms of transaction data, such as invoices.

In some embodiments, the cash flow forecasting engine 110 may predict or otherwise determine the probability or likelihood of payments being received during a particular time frame and taking that information into consideration when predicting capital shortfalls and/or capital surpluses of the entity for the given period of time. For example, the cash flow forecasting engine 110 may enhance the predicted baseline capital shortfalls or baseline capital surpluses by generating a modified prediction for the shortfalls and/or surpluses based on knowledge about the creditworthiness, a credit or trade score and/or payment history of the entity associated with the transaction data. For example, if an invoice is due to be paid on 15 Mar. 2020 according to the payment terms, but it is known from the payment history of the entity to which the invoice was issued that that entity always pays invoices at least 10 days late, that information can be used by the cash flow forecasting engine 110 to adjust the predicted capital shortfalls and/or surpluses for the time period to account for the predicted late payment. In some embodiments, a credit or trade score for a plurality or network of entities may be determined using the techniques described in PCT/US2017/045351, the entire content of which is incorporated herein by reference.

The recommendations and actions engine 112 when executed by the one or more processors of the capital management platform 102, may be configured to determine recommendations based on the predict capital shortfalls and/or capital surpluses and in some cases, to take appropriate actions. For example, such appropriate actions may comprises modifying payment terms, for example, bringing forward due dates on invoices for payers 114, deciding to incur penalty costs for later payment of invoices to payees 116, seeking financing, or investing surplus funds, for example, via a marketplace server 118 in communication with the capital management platform 102.

The capital management tool 104 may be configured to generate, on a user interface, a visual display of a predicted cash flow of the entity for the period of time based on the predicted capital shortfalls and/or capital surpluses. For example, the visual display may comprise a graphical representation of the predicted cash flow for each day of the time period. Example screenshots of the visual display of the capital management tool 104 are shown in FIGS. 3 to 5.

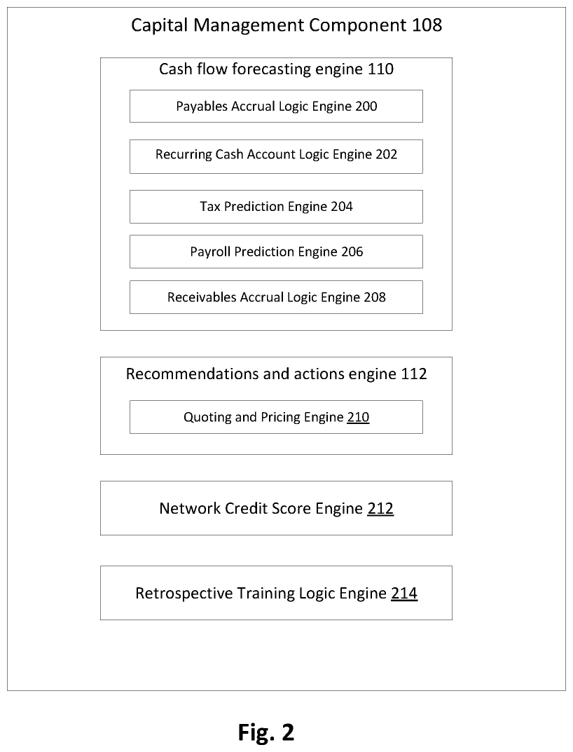

Referring now to FIG. 2, there is shown a block diagram of the modules, components or engines of the capital management component 102. As illustrated in FIG. 1, the capital management component 102 comprises the cash flow forecast engine 110 and the recommendations and actions engine 112.

As shown in FIG. 2, the cash flow forecast engine 110 may comprise a plurality of components to predict capital shortfalls and/or capital surpluses of an entity for a given period of time. The cash flow forecast engine 110 may also make iterative updates to predicted or determined cash flow forecasts based on information received from other components of the capital management component 102.

The cash flow forecast engine 110 may comprise a payables accrual logic engine 200 configured to analyse data relating to payment obligations of an entity to predict future payable obligations for the entity. The payables accrual logic engine 200 may employ a predictive model such as a regression model or a trained neural network for example and historical payables data for the entity to predict future payable obligations for the entity during a time period of interest.

The cash flow forecast engine 110 may comprise a recurring cash account logic engine 202 configured to analyse data relating to cash transactions, which may include petty cash transactions, to predict future cash transactions for the entity. Data relating to cash transactions includes data of payables or receivables in cash that an entity may engage in. The recurring cash account logic engine 202 may employ a predictive model such as a regression model or a trained neural network for example and historical data relating to cash transactions in order to predict future cash transactions that may be recurring during a given period.

The cash flow forecast engine 110 may comprise a tax prediction engine 204 configured to analyse accounting entry data to predict future tax obligations of an entity. The tax prediction engine 204 comprises jurisdiction specific taxation calculation logic to assess or estimate future tax obligations of an entity based on an assessment of revenue and expenses using financial information, such as accounting entry data retrieved from databased 106, for example.

The cash flow forecast engine 110 may comprise a payroll prediction engine 206 configured to analyse financial information, such as accounting data, related to payroll for an entity. Entities may operate with varying levels of workforce due to several factors such as seasonality, inventory levels or market conditions, for example. The payroll prediction engine 206 may employ a predictive model, such as a regression model or a trained neural network for example, and historical payroll related data in order to predict future payroll obligations for a given period.

The cash flow forecast engine 110 may comprise a receivables accrual logic engine 208 configured to analyse financial information, such as accounting data, related to receivables for payment obligations owed to the entity by other entities. The receivables accrual logic engine 208 may employ a predictive model, such as a regression model or a trained neural network for example, and historical receivables data in order to predict future receivables for a given period.

The cash flow forecast engine 110 may be configured to determine a cash flow forecast based on outputs from one or more of the payables accrual logic engine 200, a recurring cash account logic engine 202, the tax prediction engine 204, payroll prediction engine 206 and/or cash flow forecast engine 110. In some embodiments, the cash flow forecast engine 110 may be configured to determine a baseline cash flow based on these output and to generate a graphical display for displaying the cash flow forecast to user on a user interface of a client device.

The recommendations and actions engine 112 is configured to receive cash flow forecast information from the cash flow forecast engine 110 for a given time frame and to generate one or more recommendations and/or to take one or more actions to improve capital management. The recommendations and actions engine 112 may determine one or more sub-time frames of the time frame wherein the entity is predicted to have capital shortfalls and/or capital surpluses. For example, the recommendations and actions engine 112 may compare the entity's cash levels at a particular time, for example, each day of the time frame, and compare the determined cash level to a threshold, for example, a shortfall threshold and/or a surplus threshold, to determine whether the entity will have shortfall or surplus at that time.

If the cash flow forecast engine 110 determines that the entity will fall have a shortfall for a sub-time frame of the time frame, the recommendations and actions engine 112 may determine one or more recommendations to increase the cash flow for that sub-time frame. The recommendations and actions engine 112 may recommend that payment terms of invoices (either issued and unpaid or yet to be issued) be modified to increase the probability or likelihood of having increased cash flow for the sub-time frame. For example, the recommendations and actions engine 112 may bring forward due dates on those invoices, offer an incentive to the payee to pay the invoice early and/or penalise the payee for any later payment. The recommendations and actions engine 112 may cause the generation of invoices based on the recommendations for sending to the payees, for example, by issuing an instruction to an invoice generation engine (not shown). The recommendations and actions engine 112 may determine that it is appropriate to postpone payments, such as paying one or more invoices at a time later than the due date.

The recommendations and actions engine 112 may recommend that outstanding receivables be followed up on and may generate an email reminder ready for sending to the payee, for example.

The recommendations and actions engine 112 may recommend that short term finance be accessed to cover periods of cash flow shortfalls.

If the cash flow forecast engine 110 determines that the entity will fall have excess cash flow for a sub-time frame of the time frame, the recommendations and actions engine 112 may determine one or more recommendations to better utilise the cash flow, for example, by recommending appropriate short term investments.

In some embodiments, the recommendations and actions engine 112 comprises a quoting and pricing engine 210 configured to communicate with the marketplace server 118 to provide quotes and prices for financial products made available to an entity in response to a recommendation involving accessing short term debt or making short term investments. For example, if the recommendations and actions engine 112 suggests that an entity seek short term debt for a future period of capital shortfall, the quoting and pricing engine 210 may communicate the various attributes of the recommended short term debt to the marketplace server 118. The attributes of the suggested short term debt may include the amount of debt, the term of the debt, for example. The marketplace server 118 may make available the various attributes of the suggested short term debt to the marketplace and seek bids for offers of loans in response to the various parameters. The marketplace server 118 may communicate the various offers to the quoting and pricing engine 210. The quoting and pricing engine 210 may make the various offers available to the entity as part of a subsequent recommendation enabling the user to respond to one or more offers and access the short term debt.

In some embodiments, the recommendations generated by the, recommendations and actions engine 112 may be based on one or more target parameters. The target parameters may be parameters that define a desired state or level of capital for the entity or a desired state or level of risk associated with capital management. The target parameters may include a maximum debt to equity ratio for the entity, maximum weighted average cost of capital, minimum debt coverage ratio, and/or debtor days or creditor days. An entity may set one or more target parameters to a desired level depending on the nature of business and risk appetite of the entity.

In some embodiments, the recommendations and actions engine 112 may be configured to automatically execute or act on recommendations. For example, if a recommendation involves accessing short term debt to address a future cash flow shortfall, then recommendations and actions engine 112 may consider quotes provided by the quoting and pricing engine 210 to assess which of the quotes for short term debt may be acted on while maintaining conformity with the one or more target parameters. If at least one quote for short term debt may be accessed by the entity while maintaining conformity with the one or more target parameters, then the recommendations and actions engine 112 may respond to the quote with a confirmation and accordingly the entity may access short term debt to address a fixture cash flow shortfall without any human intervention while managing its risks based on the target parameters.

In some embodiments, the cash flow forecast engine 110 is configured to reassess the cash flow forecast for the time frame following actions having been taken by the recommendations and actions engine 112, or by other components of the capital management platform or by the user in response to recommendations from the recommendations and actions engine 112. For example, the baseline cash flow displayed on the graphical display on the user interface may be updated or overlayed with an adjusted cash flow forecast, which clearly depicts the impact of the recommendations on the cash flow for the time frame.

In some embodiments, the cash flow forecast engine 110 may be configured to reassess the cash flow forecast for the time frame based on a prediction as to the probability or likelihood of payments being received during a particular time frame. For example, the capital management component 108 may comprise a network credit score engine 212 configured to determine a credit score for the entities of the network based on the financial information of the database 106. In some embodiments, the credit score for any one entity may be based on transactions of the entity with one or more other entities associated with the capital management platform 102. The credit score may include an indication as to the probability or likelihood of an entity paying an invoice on time, for example. The cash flow forecast engine 110 may receive credit scores for payees of the entity, determine a probability of those payees paying invoices by the due date, and revise or adjust cash flow forecasts based on the predictions. In some embodiments, the network credit score engine 212 may be configured to perform the techniques described in PCT/US2017/045351, the entire content of which is incorporated herein by reference.

The capital management component 102 may further comprise a retrospective training logic engine 214 configured to consider the impact the recommendations of the recommendations and actions engine 112 had on the cash flow forecast of an entity and to adjust models of the recommendations and actions engine 112 to improve the performance of the capital management component 108 based on the feedback. For example, the retrospective training logic engine 214 configured to consider recommendations and action taken in response to the output of the recommendations and actions engine 112 and its impact on the cash flow position, determine a measure of effectiveness of the actions, and adjust or vary program logic or recommendation mode that drives the recommendations and actions engine 112.

Referring now to FIG. 3, there is shown an example screenshot 300 of a visual display of the capital management tool 104 provided by the capital management component 108. The screenshot 300 illustrates a graphical forecast or prediction relating to invoices and bills relating to the primary entity. Invoices may comprise future receivables from one or more counterparties or related entities. Bill may comprise future payment obligations to one or more counterparties or related entities. Section 302 provides an exemplary 30 day summary of a cash flow forecast for the primary entity's invoices and bills. Section 304 provides a graphical illustration of the cash flow forecast over the next 30 days for the entity. Points such below the x-axis in the graph 304 indicate a negative total cash flow forecast at a particular point in time. Points above the x-axis indicate a positive cash flow forecast at a particular point in time. Section 304 comprises a baseline cash flow prediction line 310 indicating the cash flow position of the primary entity over the next 30 days. Section 304 also comprises a modified cash flow prediction line 312. The modified cash flow prediction line 312 indicated a cash flow prediction for the primary entity if one or more recommendations generated by the recommendations and actions engine 112 are implemented by the primary entity. The one or more recommendations generated by the recommendations and actions engine 112 may be presented to the user in section 306 of the. Section 306 may also comprise one or more recommendation interaction user interface components 308 allowing the user to interact with a recommendation. The interaction may include accepting a recommendation, designating a date for implementation of a recommendation, or refusing a recommendation, for example.

Screenshot 300 also illustrates a selectable used input 314 allowing a user to select a particular account for which a cash flow prediction may be performed by the cash flow forecast engine 110. By selecting a different account from the selectable user input 314, a user may visualise a cash flow forecast for a different account for the entity. Screenshot 300 also illustrates another selectable user input 316 that allows a user to vary the duration over which the cash flow forecast engine 110 performs the cash flow prediction. A user may select a different duration of 60 days or 90 days, for example to view a cash flow prediction over a different timescale.

Screenshot 300 also illustrates some financial data relating to invoices and bills which provides the basis for generation of the graphs in section 304. Section 318 illustrates a summary of financial data relating to invoices for the primary entity. In section 318, the financial data is summarised by the date on which an invoice is due. Section 320 illustrates a summary of financial data relating to bills for the primary entity. In section 320, the financial data is summarised by the date on which a bill is due.

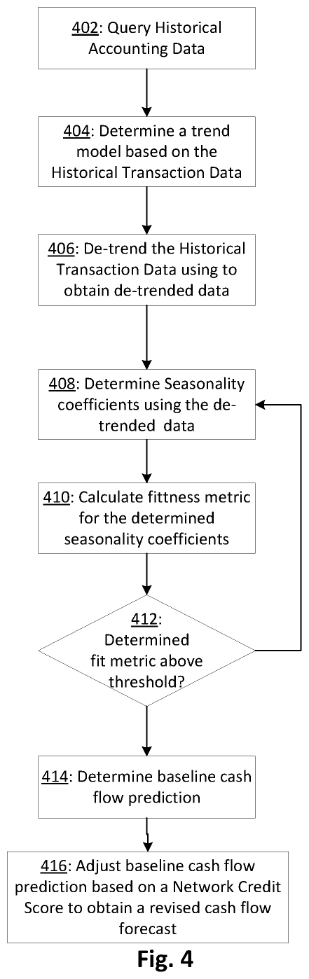

Referring now to FIG. 4, there is shown a process flow diagram 400 illustrating a method for forecasting cash flow for an entity, according to some embodiments. The cash flow forecast engine 110 may predict future cash flow of an entity based one of several techniques for predicting future cash flow based on past transactional data. The method of forecasting cash flow of FIG. 4 is an example of one of the methods of cash flow forecasting according to some embodiments.

At 402, the cash flow engine 110 determines financial or transactional data associated with a primary entity. For example, the cash flow engine 110 may query the database 106 to retrieve financial data, such as historical accounting data or transactional data, relating to the primary entity. In some embodiments, the financial data is historical time series transactional data. Each record in the historical time series transactional data may comprise an amount and a date associated with the amount. In some embodiments, each record in the historical time series transactional data may comprise an amount, a date associated with the amount and one or more other entities involved in the transaction. The historical data may provide a basis for determination of one or more models for prediction of future cash flow. Once a cash flow prediction model is determined for a particular entity, the model may be varied over time as more data is made available to improve the accuracy of the cash flow prediction model. The transactional data may include data relating to one or more of: bank account transactions or transfers data, invoice data, billings data, expense claim data, cash flow data, quotes related data, sales data, purchase order data, receivables data, transaction reconciliation data, balance sheet data, profit and loss data, payroll data, for example.

### Each Record

In some embodiments, the historical transactional data comprises one or more of a trend component, a seasonality component and a noise component. The trend component comprises an overall long term trend in the historical transactional data. For example, if the transactional data relates to sales of a particular product, and the overall demand of the particular product has been rising over time, then the trend component of the transaction data will reflect the rising overall demand or sales. The seasonality component comprises variation in the transactional data over fixed time periods. For example, if the transactional data relates to sales of a product which is in greater demand in the summer months rather than the winter months, then the seasonality component may reflect the seasonal variation in the transactional data relating to the sales. The seasonal component may have a monthly periodicity, weekly periodicity or daily periodicity, for example. For example, the seasonal components of a transactional data relating to sales of a business not open during the weekends may have a daily periodicity reflecting no sales on Saturdays or Sundays. Depending on the nature of the underlying transactional data, an appropriate periodicity for the seasonal component may be selected to best reflect historical data and more accurately predict future cash flow for the primary entity. It will be appreciated that in some situations, there is little or no variation in the transactional data over fixed time periods, and in such cases, the seasonality component may be nil. In some embodiments, the historical transactional data comprises a noise component. The noise component may reflect variations or changes in transactional data not explained by the trend or seasonality component. Typically, the noise component will be a very small part of the transaction data and it may be ignored by the cash flow forecasting engine 110.

In some embodiments, the cash flow forecast engine 110 may model the time series historical transactional data using an additive model based on the equation “y(t)=a(t)+s(t)+n”. In the additive model, y(t) represents historical time series transactional data, a(t) represents the trend component, s(t) represents the seasonality component, n represents noise. In some embodiments, the cash flow forecast engine 110, may model the time series historical transactional data using an multiplicative model based on the equation “y(t)=a(t)*s(t)+n”.

At 404, where a trend component (a(t)) is determined, the cash flow forecast engine 110 determines a regression model for the trend component (a(t)) of a historical time series transactional data. Various regression analysis techniques, including linear and non-linear regression models may be used to determine a model for the trend component (a(t)). In some embodiments, a linear model in the form of “a(t)=intercept+slope*t” may be used to model the trend component. The values of “intercept” and “slope” coefficients may be determined by one or more estimation methods including: least-squares estimation, maximum-likelihood estimation, for example. With the values of “intercept” and “slope” coefficients determined a model for the trend component of the historical time series transactional data is obtained that can be projected into the future to provide future trend estimates.

At 406, based on the regression model of the trend component obtained at 404, the historical time series transaction data is de-trended or in essence, the trend component is removed from the historical time series transaction data to obtain de-trended data. In some embodiments, the de-trended data comprises one or more of: the seasonal component and the noise component. The de-trended historical time series transaction data may be obtained by dividing the historical time series transaction data by the trend component in embodiments where a multiplicative model is used. The de-trended historical time series transaction data may be obtained by subtracting the historical time series transaction data by the trend component in embodiments where an additive model is used.

At 408, where a seasonality component s(t) is determined, the cash flow forecast engine 110 determines one or more seasonality coefficients based on the de-trended historical time series transaction data obtained at 406. Seasonality coefficients define the s(t) function as discussed above and reflect a seasonal character or variation of the historical time series transaction data. Seasonality components may be determined at various periodicities. In some embodiments, the cash flow forecast engine 110 may initially assume that the seasonality component has a larger periodicity (for example, a monthly periodicity). Seasonality coefficients may be calculated on this initial assumption, and an error (or fitness metric) in the calculated seasonality coefficients fitting the historical time series transactional data may be calculated at 410 to assess whether the assumed periodicity appropriately models the seasonal trend in the historical time series transactional data. If the calculated error or fitness metric does not appropriately model the seasonal components, or is above a certain error threshold, then a different, shorter periodicity may be assumed for calculation of the seasonality coefficients.

The seasonality coefficients may be determined at 408 by processing the de-trended time series transactional data to obtain a coefficient for each seasonal cycle (month of year, week of month, day of week) that best models the seasonal component. The seasonality coefficients may be obtained by averaging the de-trended time series transactional data over a period of time. For example, to obtain seasonality coefficients for the month of January (when the periodicity is assumed to be a month of the year), the de-trended time series transactional data for the month of January may be averaged over a certain period of time to obtain the seasonality coefficient for the month of January. Similarly seasonality coefficients for other months may be calculated for the entire year. The seasonality coefficients for other smaller periodicities (week of month, day of week) may be determined using the same approach.

Having determined a regression model for the trend component at 404 and the seasonality coefficients at 408, a fitness metric or an error metric is determined at 410. The fitness metric or error metric indicates how well the determined trend component and seasonality coefficients model the historical time series transactional data. The fitness metric or error metric may be calculated by calculating the difference between the historical time series transaction data and the modelled trend component and seasonality coefficient. A mean, variance or other statistical measure of the difference may be used as the fitness metric or error metric.

At 412, the cash flow forecast engine 110 determines whether the fitness metric calculated at 410 is above a certain fitness threshold indicating an acceptable degree of fitness and accuracy of the trend model and seasonality coefficients. If the fitness metric calculated at 410 is below the threshold, then the cash flow forecast engine 110 may reduce the periodicity of the seasonality component and recalculate the seasonality coefficients at 410 using the smaller periodicity to obtain seasonality coefficients that better model the historical time series transactional data. In some embodiments, the historical time series transactional data may comprise a combination of seasonal patterns. For example, the historical time series transactional data may have a pattern for a month of the year, another pattern for week of the month and another pattern for day of the week. In such embodiments, seasonality coefficients for the various different periodicities may be calculated to most accurately model the historical time series transactional data.

At 414, based on the determined trend model at 404 and the seasonality coefficients at 408, cash flow forecast engine 110 determines future cash flow predictions. The steps 402 to 412 may be performed separately for different categories of historical transaction data records for an entity. For example, steps 402 to 412 may be separately performed for an entity's sales transaction data, expenses transaction data, payroll transaction data, for example. The historical transaction data may be appropriately characterised and sectored or categorised to individually model each sector or category. At step 414, the output of each model determined for an entity may be projected into the future to determine an overall future cash flow prediction for the entity.

At 416, in some embodiments, the cash flow forecast engine 110 may query the network credit score engine 212 that may be configured to perform the techniques described in PCT/US2017/045351 to obtain network credit score for counterparties or related entities or third parties. Based on the obtained network credit scores, the cash flow prediction determined at 414 may be varied or adjusted to take into account the financial position of counterparties or related entities or third parties and obtain a more accurate cash flow prediction for the entity. The network credit score engine 212 may be configured to determine a probability or likelihood of a creditor paying an invoice within a particular payment period and this information may be used to recalibrate the cash flow prediction for the primary entity. For example, if it is determined that creditor is unlikely to pay an invoice issued by the primary entity by a due date, the cash flow forecast engine 110 will factor this into the prediction and not expect to receive that payment on the due date.

The various modules of the cash flow forecasting engine 110: Payables Accrual Logic Engine 200, Recurring Cash Account Logic Engine 202, Tax Prediction Engine 204, Payroll Prediction Engine 206, Receivables Accrual Logic Engine 208 may implement the process flow of FIG. 4 to determine a cash flow forecast of their respective transactional domains. Output from each of the modules within the cash flow forecasting engine 110 may be combined by the cash flow forecasting engine 110 to determine an overall cash flow forecast for an entity.

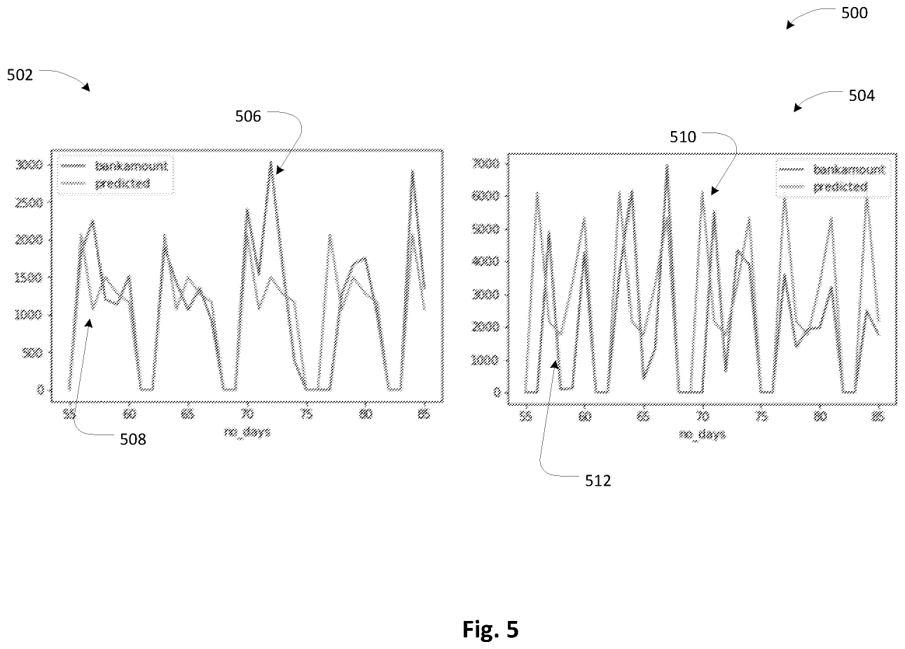

FIG. 5 illustrates first and second charts 502, and 504, respectively, obtained by implementing the process flow 400 of FIG. 4 using test historical transaction data. The X-axis of both charts 502 and 504 corresponds to a historical transaction amount or a predicted transaction amount and the Y-axis of both charts 502 and 504 corresponds to a date. Line graphs 506 and 510 in charts 502 and 504, respectively, represent actual transactional data for a particular entity. Line graphs 508 and 512 in charts 502 and 504, respectively, represent predicted transactional data for a particular entity based on historical transactional data. As is observable from charts 502 and 504, the predicted transaction data and the actual transaction data closely align during a significant portion of the time periods in charts 502 and 504. Predictions for several categories of transaction data for a particular entity may be combined to obtain an overall cash flow prediction for an entity as illustrated in section 304 of FIG. 3.

FIG. 6 is a block diagram depicting an example capital management platform 600, according to some embodiments. The example capital management platform 600 may provide accounting tools to a particular entity managing accounting for one or more businesses. The example capital management platform 600 may include a practice studio 610 that allows an entity to manage one or more businesses and an organization access component 650 that provides a business with tools for managing accounting data for that particular business. The practice studio 610 may include a practice profile management component 612, a practice staff management component 614, an online training component 616, a practice management component 618, a partner resources component 620, a report packs setup component 622, and a work papers component 624. The practice studio 610 may be in communication with core features 630. The core features 630 may include an accounting and payroll component 632 (including capital management component 108), a community component 634, a billing/subscription management component 636, a notifications centre component 638, a user profile management component 640, and a login component 642. The organization access component 650 may be in communication with the core features 630. The practice studio 610 and core features may be accessed by an entity using login component 642. The features of the practice studio 610 provide a suite of tools for accountants to interact with their clients and manage their practices. The core features 630 provide the core functionality and user tools common to both accountants and businesses. The organization access component 650 provides a user interface for individual businesses to access their data.

The accounting and payroll component 632 provides the general ledger for organizations. The general ledger may be integrated with the organization's payroll, bypassing the separate step of entering payroll data into the general ledger each pay period. The accounting and payroll component 632 accesses banking data for each client business. The banking data may be imported either through a bank feed or a user- or accountant-created document. The accounting and payroll component 632 may also communicate with third-party tools via an application protocol interface (API).

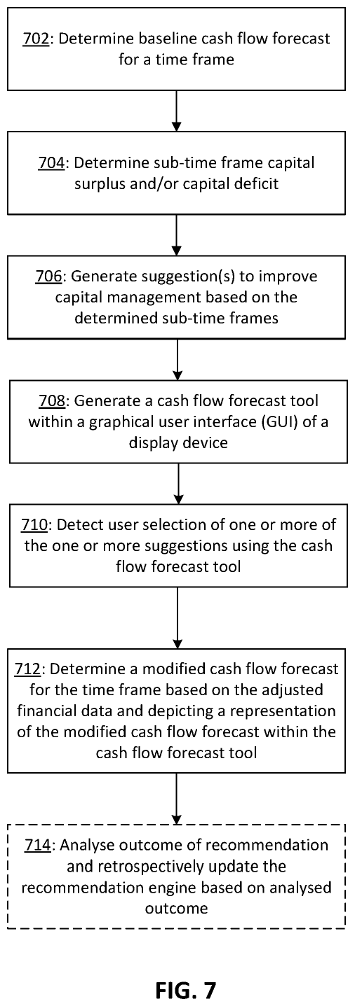

The capital management component 108 enables generation of a capital management or cash flow forecast predictions and effective actions for improving capital position. The capital management component 108 may interact with the accounting and payroll component 632, the billing/subscription management component 636, and the notifications centre 638, for example, to perform data processing operations on financial data, including data corresponding to inflow and outflow financial transactions. FIG. 7 is a flowchart of a method 700 for managing capital for a primary entity, according to some example embodiments.

At 702, the cash flow forecasting engine 110 determines a cash flow forecast for the primary entity over a certain period of time in the future. The period of time may be 30 days, 60 days, 90 days or 6 months or an year for example. The cash flow forecasting engine 110 may generate the cash flow forecast based on the process flow diagram of FIG. 4. The generated cash flow forecast may be presented to a user in the form of a graph 304 as illustrated in FIG. 3.

At 704, a sub-time frame capital surplus or capital shortfall is determined by the cash flow forecasting engine 110. This may involve identifying time periods wherein the primary entity may have excess cash (cash flow surplus) that could be used for specific purposes or alternatively time periods wherein the primary entity will experience cash flow shortfalls requiting the primary entity to take corrective action in advance or in response to the cash flow shortfall. The sub-time frames identified may have a start date and an end date.

At 706, the recommendations and actions engine 112 may take into account the sub-time frames of capital surplus and shortfall at 704 to determine recommendations or suggestions to improve the capital or cash flow position of the primary entity in response to the predicted periods of cash flow surplus or shortfall. The recommendations and actions engine 112 may comprise one or more machine learning models trained to accept as input the cash flow forecast generated at 702, other financial transaction data or balance sheet data of the primary entity stored in database 106. The recommendations and actions engine 112 may also be configured to take into account one or more financial target parameters. The target parameters may be parameters that define a desired state or level of capital for the entity or a desired state or level of risk associated with capital management. The target parameters may include a maximum debt to equity ratio for the entity, maximum weighted average cost of capital, minimum debt coverage ratio, and/or debtor days or creditor days. An entity may set one or more target parameters to a desired level depending on the nature of business and risk appetite of the entity.

The recommendations and actions engine 112 may comprise one or more machine learning models comprising one or more: artificial neural networks, intelligent agents, nonparametric models, support vector machines, probabilistic models, for example. Each of the various machine learning frameworks may be initially trained or configured using a training dataset comprising cash flow forecasts for an entity, sub-time frames or cash flow shortfall or surplus, financial target parameters and one or more recommendations for each sub-time frame of capital shortfall or surplus. The trained machine learning models at 706 may take into account each sub-time frame of capital shortfall or surplus for the primary entity, the target financial parameters from the financial entity and generate recommendations for the primary entity to improve its cash flow at each sub-time frame of cash flow shortfall or surplus.

In some embodiments, generation of recommendations at 706 may comprise transmission of a quote request query to the marketplace server 118 by the capital management platform 102. In some embodiments, a recommendation generated by the recommendations and actions engine 112 may include a recommendation to seek short term finance to cover a period or sub-time frame of cash flow shortfall. The recommendation of seeking short term finance may also include one or more financial products suitable for the primary entity based on its financial position and needs. The quote request query to the marketplace server 118 may include financial details of the primary entity and its short term cash flow needs. The marketplace server 118 may make the financial information of the primary entity available to one or more financing entities such as banks allowing them to offer or quote one or more financial products that address the financial needs of the primary entity. In some embodiments, a recommendation for a sub-time frame of cash flow surplus for the primary entity may include investment of the surplus cash flow in a financial product. In such embodiments, the offers or quote from the marketplace server 118 may include offers or quotes for investment products suitable to the primary entity's financial position. The offers or quotes regarding the financial products suitable for the primary entity may be provided to the capital management platform 102.

At 708, a cash flow forecast tool is generated by the capital management platform 102 within a graphical user interface (GUI) of a display device. The GUI may comprise recommendations generated at 706 that may be presented to a user. In some embodiments, the recommendations and actions engine 112 may overlay the recommendations on a cash flow surplus or shortfall graph as illustrated in FIG. 3. In some embodiments, each recommendation may be presented on a portion of the graph corresponding to the sub-time frame to which the recommendation applies to. The GUI may provide an intuitive presentation of the one or more recommendations overlayed on a cash flow forecast graph allowing the user to conveniently review the recommendations. Recommendations may also include quotes and details of the financial products obtained from the marketplace server 118. In some embodiments, the GUI may also comprise a revised cash flow forecast based on a hypothetical acceptance of one or more recommendations to provide the user a visualisation of the impact of acceptance of a recommendation on the cash flow forecast for the primary entity.

At 710, a user selection of one or more of the one or more suggestions using the cash flow forecast tool may be detected by the cash flow forecast tool. The user may interact with the one or more recommendations presented at 708. The user may approve the implementation of a recommendation. The approval may include a date or time period for execution of the recommendation. The user's instruction may be stored by the recommendations and action engine 112 for execution. The execution may involve the purchase of or subscription to a financial product recommended by the marketplace server 118. The execution may occur at a time designated by the user at 710.

At 712 a modified cash flow forecast may be determine for the time frame based on the user selection at 710 in relation to the one or more suggestions and adjusted financial data. The modified cash flow forecast may be depicted within the cash flow forecast tool as exemplified in FIG. 3. The modified cash flow may be determined based on modified financial data adjusted on the assumption that the user selected one or more recommendations are implemented by the entity. The modified cash flow forecast depicted within the cash flow forecast tool may enable the user too assess and compare the various recommendations the their respective impact of the future cash flow position of the entity.

At 714, the retrospective training logic engine 214 considers the cash flow prediction generated at 702, the recommendations generated at 706 and the user selection of recommendations at 710 to assess the effectiveness of the recommendations generated by the recommendations and action engine 112. The assessment may occur after the sub-time from to which the generated recommendations applied has passed and actual cash flow data of the primary entity is available over the sub-time frame. The assessment may involve the retrospective training logic engine 214 comparing the predicted cash flow at 702 with actual cash flow data obtained from database 106 and identifying whether the sub-time frames of cash flow shortfalls were addressed by the recommendations or alternatively whether the surplus capital during the sub-times frames provided adequate investment returns. Based on the assessment, the retrospective training logic engine 214 may generate feedback signals regarding suitability or unsuitability of the one or more recommendations. The feedback may be provided as an input the machine learning models of the recommendations and action engine 112. The machine learning models of the recommendations and action engine 112 may take into account this feedback to revise or retrain its models to provide improved recommendations in the future. The feedback based on actual outcomes associated with the recommendations may improve the quality and reliability of future recommendations generated by the recommendations and action engine 112,

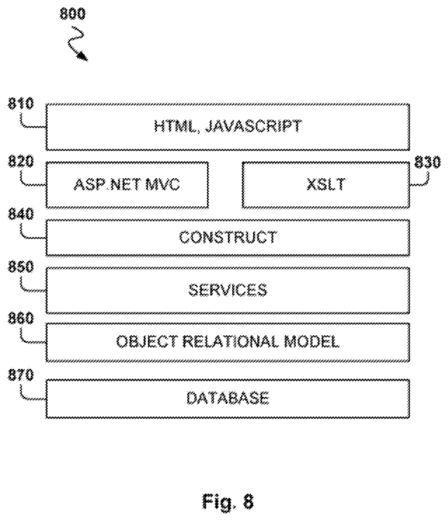

FIG. 8 is a block diagram depicting an example application framework 800, according to some embodiments. The application framework 800 may be an end-to-end web development framework enabling a “software as a service” (SaaS) product. The application framework 800 may include a hypertext markup language (HTML) and/or JavaScript layer 810, ASP.NET Model-View-Controller (MVC) 820, extensible stylesheet language transformations (XSLT) 830, construct 840, services 850, object relational model 860, and database 870.

The HTML and/or JavaScript layer 810 provides client-side functionality, such as user interface (UI) generation, receipt of user input, and communication with a server. The client-side code may be created dynamically by the ASP.NET MVC 820 or the XSLT 830. Alternatively, the client-side code may be statically created or dynamically created using another server-side tool. The ASP.NET MVC 820 and XSLT 830 provide server-side functionality, such as data processing, web page generation, and communication with a client. Other server-side technologies may also be used to interact with the database 870 and create an experience for the user.

The construct 840 provides a conduit through which data is processed and presented to a user. For example, the ASP.NET MVC 820 and XSLT 830 can access the construct 840 to determine the desired format of the data. Based on the construct 840, client-side code for presentation of the data is generated. The generated client-side code and data for presentation is sent to the client, which then presents data. In some example embodiments, when the MLP is invoked to analyze an entry, the MVC website makes an HTTP API call to a Python-based server. Also, the MVC website makes another HTTP API call to the Python-based server to present the suggestions to the user. The services 850 provide reusable tools that can be used by the ASP.NET 820, the XSLT 830, and the construct 840 to access data stored in the database 870. For example, aggregate data generated by calculations operating on raw data stored in the database 870 may be made accessible by the services 850.

The object relational model 860 provides data structures usable by software to manipulate data stored in the database 870. For example, the database 870 may represent a many-to-one relationship by storing multiple rows in a table, with each row having a value in common. By contrast, the software may prefer to access that data as an array, where the array is a member of an object corresponding to the common value. Accordingly, the object relational model 860 may convert the multiple rows to an array when the software accesses them and perform the reverse conversion when the data is stored.

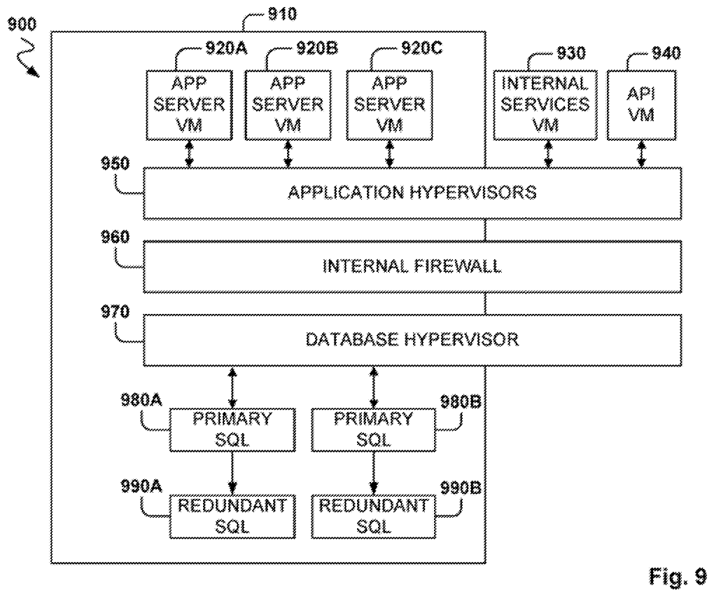

FIG. 9 is a block diagram depicting an example hosting infrastructure 900, according to some embodiments. The platform 600 may be implemented using one or more pods 910. Each pod 910 includes application server virtual machines (VMs) 920 (shown as application server virtual machines 920A-920C in FIG. 9) that are specific to the pod 910 as well as application server virtual machines that are shared between pods 910 (e.g., internal services VM 930 and application protocol interface VM 940). The application server virtual machines 920-940 communicate with clients and third-party applications via a web interface or an API. The application server virtual machines 920-940 are monitored by application hypervisors 950. In some example embodiments, the application server virtual machines 920A-920C and the API VM 940 are publicly accessible while the internal services VM 930 is not accessible by machines outside of the hosting infrastructure 900. The app server VMs 920A-920C may provide end-user services via an application or web interface. The internal services VM 930 may provide back-end tools to the app server VMs 920A-920C, monitoring tools to the application hypervisors 950, or other internal services. The API VM 940 may provide a programmatic interface to third parties. Using the programmatic interface, the third parties can build additional tools that rely on the features provided by the pod 910. An internal firewall 960 ensures that only approved communications are allowed between the database hypervisor 970 and the publicly accessible virtual machines 920-940. The database hypervisor 970 monitors the primary SQL servers 980A and 980B and the redundant SQL servers 990A and 990B. The virtual machines 920-940 can be implemented using Windows 8008 R2, Windows 8012, or another operating system. The support servers can be shared across multiple pods 910. The application hypervisors 950, internal firewall 960, and database hypervisor 970 may span multiple pods 910 within a data centre.

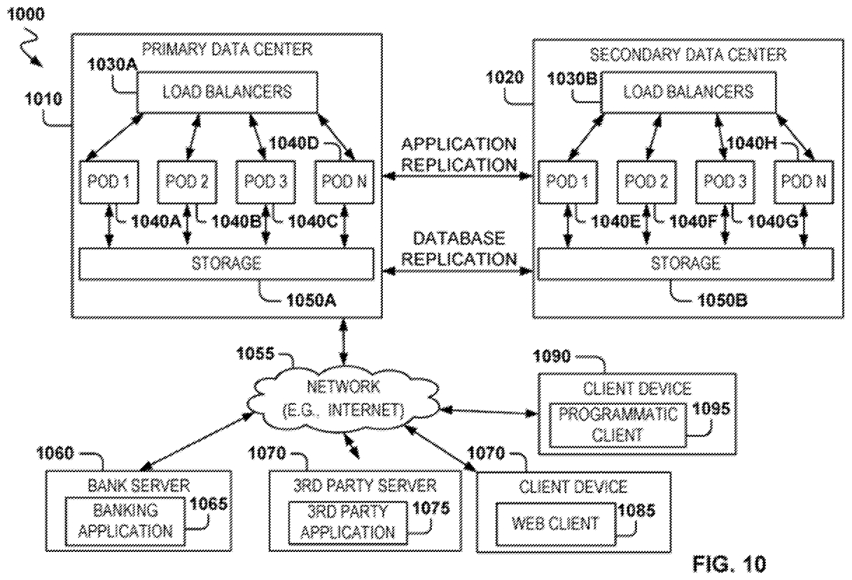

FIG. 10 is a block diagram depicting an example data centre system 1000 for implementing embodiments. The primary data centre 1010 services customer requests and is replicated to the secondary data centre 1020. The secondary data centre 1020 may be brought online to serve customer requests in case of a fault in the primary data centre 1010. The primary data centre 1010 communicates over a network 1055 with bank server 1060, third party server 1070, client device 1070, and client device 1090. The bank server provides banking data (e.g., via a banking application 1065). The third-party server 1070 is running third party application 1075. Client devices 1080 and 1090 interact with the primary data centre 1010 using web client 1085 and programmatic client 1095, respectively. Within each data centre 1010 and 1020, a plurality of pods, such as the pod 910 of FIG. 9, are shown. The primary data centre 1010 is shown containing pods 1040a-1040d. The secondary data centre 1020 is shown containing pods 1040e-1040h. The applications running on the pods of the primary data centre 1010 are replicated to the pods of the secondary data centre 1020. For example, EMC replication (provided by EMC Corporation) in combination with VMWare site recovery manager (SRM) may be used for the application layer replication. The database layer handles replication between a storage layer 1050a of the primary data centre and a storage layer 1050b of the secondary data centre. Database replication provides database consistency and the ability to ensure that all databases are at the same point in time. The data centres 1010 and 1020 use load balancers 1030a and 1030b, respectively, to balance the load on the pods within each data centre. The bank server 1060 interacts with the primary data centre 1010 to provide bank records for bank accounts of the client. For example, the client may provide account credentials to the primary data centre 1010, which the primary data centre 1010 uses to gain access to the account information of the client.

The bank server 1060 can provide the banking records to the primary data centre 1010 for later reconciliation by the client using the client device 1080 or 1090. The third-party server 1070 may interact with the primary data centre 1010 and the client device 1080 or 1090 to provide additional features to a user of the client device 1080 or 1090.

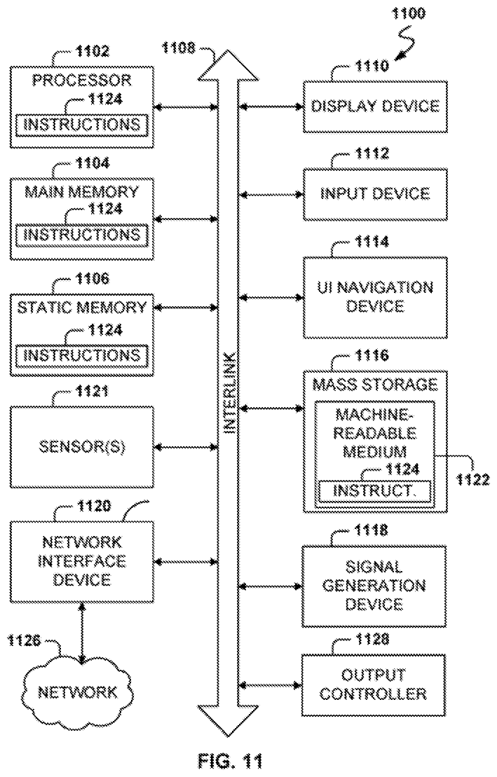

FIG. 11 is a block diagram illustrating an example of a machine upon which one or more example embodiments may be implemented. In alternative embodiments, the machine 1100 may operate as a standalone device or may be connected (e.g., networked) to other machines. In a networked deployment, the machine 1100 may operate in the capacity of a server machine, a client machine, or both in server-client network environments. In an example, the machine 1100 may act as a peer machine in peer-to-peer (P2P) (or other distributed) network environment. The machine 1100 may be a personal computer (PC), a tablet PC, a set-top box (STB), a laptop, a mobile telephone, a web appliance, a network router, switch or bridge, or any machine capable of executing instructions (sequential or otherwise) that specify actions to be taken by that machine. Further, while only a single machine 1100 is illustrated, the term “machine” shall also be taken to include any collection of machines that individually or jointly execute a set (or multiple sets) of instructions to perform any one or more of the methodologies discussed herein, such as cloud computing, SaaS, or other computer cluster configurations.

Examples, as described herein, may include, or may operate by, logic or a number of components, or mechanisms. Circuitry is a collection of circuits implemented in tangible entities that include hardware (e.g., simple circuits, gates, logic, etc.). Circuitry membership may be flexible over time and underlying hardware variability. Circuitries include members that may, alone or in combination, perform specified operations when operating. In an example, hardware of the circuitry may be immutably designed to carry out a specific operation (e.g., hardwired). In an example, the hardware of the circuitry may include variably connected physical components (e.g., execution units, transistors, simple circuits, etc.) including a computer-readable medium physically modified (e.g., magnetically, electrically, moveable placement of invariant massed particles, etc.) to encode instructions of the specific operation.

In connecting the physical components, the underlying electrical properties of a hardware constituent are changed, for example, from an insulator to a conductor or vice versa. The instructions enable embedded hardware (e.g., the execution units or a loading mechanism) to create members of the circuitry in hardware via the variable connections to carry out portions of the specific operation when in operation. Accordingly, the computer-readable medium is communicatively coupled to the other components of the circuitry when the device is operating. In an example, any of the physical components may be used in more than one member of more than one circuitry. For example, under operation, execution units may be used in a first circuit of a first circuitry at one point in time and reused by a second circuit in the first circuitry, or by a third circuit in a second circuitry, at a different time.

The machine (e.g., computer system) 1100 may include a hardware processor 1102 (e.g., a central processing unit (CPU), a graphics processing unit (GPU), a hardware processor core, or any combination thereof), a main memory 1104, and a static memory 1106, some or all of which may communicate with each other via an interlink (e.g., bus) 1108. The machine 1100 may further include a display device 1110, an alphanumeric input device 1112 (e.g., a keyboard), and a UI navigation device 1114 (e.g., a mouse). In an example, the display device 1110, input device 1112, and UI navigation device 1114 may be a touch screen display. The machine 1100 may additionally include a mass storage device (e.g., drive unit) 1116, a signal generation device 1118 (e.g., a speaker), a network interface device 1120, and one or more sensors 1121, such as a global positioning system (GPS) sensor, compass, accelerometer, or another sensor. The machine 1100 may include an output controller 1128, such as a serial (e.g., universal serial bus (USB), parallel, or other wired or wireless (e.g., infrared (IR), near field communication (NFC), etc.) connection to communicate or control one or more peripheral devices (e.g., a printer, card reader, etc.).

The storage device 1116 may include a machine-readable medium 1122 on which is stored one or more sets of data structures or instructions 1124 (e.g., software) embodying or utilized by any one or more of the techniques or functions described herein. The instructions 1124 may also reside, completely or at least partially, within the main memory 1104, within static memory 1106, or within the hardware processor 1102 during execution thereof by the machine 1100. In an example, one or any combination of the hardware processor 1102, the main memory 1104, the static memory 1106, or the storage device 1116 may constitute machine-readable media.

While the machine-readable medium 1122 is illustrated as a single medium, the term “machine-readable medium” may include a single medium or multiple media (e.g., a centralized or distributed database, and/or associated caches and servers) configured to store the one or more instructions 1124.

The term “machine-readable medium” may include any medium that is capable of storing, encoding, or carrying instructions 1124 for execution by the machine 1100 and that cause the machine 1100 to perform any one or more of the techniques of the present disclosure, or that is capable of storing, encoding or carrying data structures used by or associated with such instructions 1124. Non-limiting machine-readable medium examples may include solid-state memories, and optical and magnetic media. In an example, a massed machine-readable medium comprises a machine-readable medium 1122 with a plurality of particles having invariant (e.g., rest) mass. Accordingly, massed machine-readable media are not transitory propagating signals. Specific examples of massed machine-readable media may include: non-volatile memory, such as semiconductor memory devices (e.g., Electrically Programmable Read-Only

Memory (EPROM), Electrically Erasable Programmable Read-Only Memory (EEPROM)) and flash memory devices; magnetic disks, such as internal hard disks and removable disks; magneto-optical disks; and CD-ROM and DVD-ROM disks. The instructions 1124 may further be transmitted or received over a communications network 1126 using a transmission medium via the network interface device 1120 utilizing any one of a number of transfer protocols (e.g., frame relay, internet protocol (IP), transmission control protocol (TCP), user datagram protocol (UDP), hypertext transfer protocol (HTTP), etc.). Example communication networks may include a local area network (LAN), a wide area network (WAN), a packet data network (e.g., the Internet), mobile telephone networks (e.g., cellular networks), Plain Old Telephone (POTS) networks, and wireless data networks (e.g., Institute of Electrical and Electronics Engineers (IEEE) 1102.11 family of standards known as Wi-Fi®, IEEE 1102.16 family of standards known as WiMax®), IEEE 1102.15.4 family of standards, peer-to-peer (P2P) networks, among others. In an example, the network interface device 1120 may include one or more physical jacks (e.g., Ethernet, coaxial, or phone jacks) or one or more antennas to connect to the communications network 1126.

In an example, the network interface device 1120 may include a plurality of antennas to wirelessly communicate using at least one of single-input multiple-output (SIMO), multiple-input multiple-output (MIMO), or multiple-input single-output (MISO) techniques. The term “transmission medium” shall be taken to include any intangible medium that is capable of storing, encoding or carrying instructions 1124 for execution by the machine 1100, and includes digital or analog communications signals or other intangible medium to facilitate communication of such software.

Throughout this specification, plural instances may implement components, operations, or structures described as a single instance. Although individual operations of one or more methods are illustrated and described as separate operations, one or more of the individual operations may be performed concurrently, and nothing requires that the operations be performed in the order illustrated. Structures and functionality presented as separate components in example configurations may be implemented as a combined structure or component. Similarly, structures and functionality presented as a single component may be implemented as separate components. These and other variations, modifications, additions, and improvements fall within the scope of the subject matter herein. The embodiments illustrated herein are described in sufficient detail to enable those skilled in the art to practice the teachings disclosed. Other embodiments may be used and derived therefrom, such that structural and logical substitutions and changes may be made without departing from the scope of this disclosure. The Detailed Description, therefore, is not to be taken in a limiting sense, and the scope of various embodiments is defined only by the appended claims, along with the full range of equivalents to which such claims are entitled.

As used herein, the term “or” may be construed in either an inclusive or exclusive sense. Moreover, plural instances may be provided for resources, operations, or structures described herein as a single instance. Additionally, boundaries between various resources, operations, modules, engines, and data stores are somewhat arbitrary, and particular operations are illustrated in a context of specific illustrative configurations. Other allocations of functionality are envisioned and may fall within a scope of various embodiments of the present disclosure. In general, structures and functionality presented as separate resources in the example configurations may be implemented as a combined structure or resource. Similarly, structures and functionality presented as a single resource may be implemented as separate resources. These and other variations, modifications, additions, and improvements fall within a scope of embodiments of the present disclosure as represented by the appended claims. The specification and drawings are, accordingly, to be regarded in an illustrative rather than a restrictive sense.

It will be appreciated by persons skilled in the art that numerous variations and/or modifications may be made to the above-described embodiments, without departing from the broad general scope of the present disclosure. The present embodiments are, therefore, to be considered in all respects as illustrative and not restrictive.

1. A computer implemented method comprising:
determining a baseline cash flow forecast for a time frame based on financial data associated with the primary entity for that time frame;
determining one or more sub-time frames of the time frame where cash flow is predicted to be in surplus or deficit; and
based on the determined sub-time frames, generating by a recommendation engine, one or more recommendations to improve capital management for the primary entity;
wherein determining the baseline cash flow forecast for the time frame comprises assessing the financial data to determine predicted capital surplus and/or capital deficit within the time frame.

2. The method of claim 1, wherein the financial data comprises transactions between the primary entity and one or more other entities.

3. The method of claim 2, wherein determining the baseline cash flow forecast comprises:
determining a trend component based on the financial data associated with the primary entity for that time frame,
determining a first seasonality component based on the financial data,
projecting the trend component and the first seasonality component to the time frame to determine the baseline cash flow forecast.

4. The method of claim 3, wherein determining the baseline cash for forecast comprises:
determining the first seasonality component based on a first periodicity in the financial data;
determining a fitness metric by comparing the financial data with the trend model and the seasonality component;
if the determined fitness metric is below a predetermined fitness threshold, determining a second seasonality component based on a second periodicity in the financial data; and
projecting the trend component and the second seasonality component to the time frame to determine the baseline cash flow forecast.

5. The method of claim 4, wherein the first periodicity is larger than the second periodicity.

6. The method of claim 1, further comprising predicting a probability of receiving payment of each invoice having a due date in the time frame and determining a modified cash flow forecast for the time frame based on the predictions.

7. The method of claim 6, wherein predicting a probability of receiving payment of each invoice having a due date in the time frame comprises determining an action score for a secondary entity associated with each invoice,
wherein the action score is based on historic payment related data of the respective secondary entity, and determining the probability of the second entity paying the invoice within a given payment period, wherein the given period falls within the time frame.

8. The method of claim 7, wherein the given period is a specific day within the time frame.

9. The method of claim 1, further comprising generating a cash flow forecast tool within a graphical user interface (GUI) of a display device, wherein the cash flow forecast tool depicts a representation of the baseline cash flow forecast and the one or more recommendations.

10. The method of claim 1, wherein the one or more recommendations comprise recommendations to adjust the financial data to manage the predicted cash flow during the one or more sub-time frames.

11. The method of claim 10, wherein the method further comprises: in response to detecting user selection of one or more of the one or more suggestions using the cash flow forecast tool, adjusting the financial data in accordance with the selected one or more suggestions,
determining a modified cash flow forecast for the time frame based on the adjusted financial data and depicting a representation of the modified cash flow forecast within the cash flow forecast tool.

12. The method of claim 11, wherein adjusting financial data comprises modifying a due date for payment on an invoice.

13. The method of claim 1, wherein the recommendations include one or more of: seeking early payment of an outstanding invoice, seeking an extended term for payment of an outstanding invoice, subscribing to a financial product, varying terms of at least one of the one or more transactions.

14. The method of claim 1, wherein the recommendations are generated based on one or more capital management target parameters.

15. The method of claim 14 wherein the capital management target parameters comprise one or more of: debt to equity ratio for the entity, weighted average cost of capital to the entity, debt coverage ratio for the entity, number of debtor days for the entity or number of creditor days for the entity.

16. The method of claim 14, further comprising automatically executing at least one of the recommendations based on the target parameters.

17. The method of claim 16, further comprising analysing the automatically executed recommendations to determine whether the executed capital management recommendations mitigated the forecasted one or more cash flow shortfall periods or one or more cash flow excess periods; and revising the recommendation engine based on the analysis.

18. The method of claim 17, wherein the recommendation engine comprises one or more machine learning models and the revising the recommendation engine comprises training the machine learning model based on the analysis.

19. (canceled)

20. (canceled)

21. A system for comprising:
one or more processors;
a memory in communication with the one or more processor, the memory comprising program code which when executed by the one or more processors configures the one or more processors to:
determine a baseline cash flow forecast for a time frame based on financial data associated with the primary entity for that time frame;
determine one or more sub-time frames of the time frame where cash flow is predicted to be in surplus or deficit;
based on the determined sub-time frames, generating by a recommendation engine one or more recommendations to improve capital management for the primary entity;
wherein determining the baseline cash flow forecast for the time frame comprises assessing the financial data to determine predicted capital surplus and/or capital deficit within the time frame.

22-40. (canceled)

41. A machine-readable medium storing computer readable code,
which when executed by one or more processors is configured to perform operations including:
determining a baseline cash flow forecast for a time frame based on financial data associated with the primary entity for that time frame;
determining one or more sub-time frames of the time frame where cash flow is predicted to be in surplus or deficit; and
based on the determined sub-time frames, generating by a recommendation engine, one or more recommendations to improve capital management for the primary entity;
wherein determining the baseline cash flow forecast for the time frame comprises assessing the financial data to determine predicted capital surplus and/or capital deficit within the time frame.
